(19) United States
(12) Patent Application Publication
(10) Pub. No.: US 2016/0188631 A1
(43) Pub. Date: Jun. 30, 2016

(54) LOCATING CALL MEASUREMENT DATA

(71) Applicant: Alcatel-Lucent USA Inc., Murray Hill, NJ (US)

(72) Inventors: Supratim Deb, East Brunswick, NJ (US); Avik Ray, Springfield, NJ (US)

(21) Appl. No.: 14/586,656

(22) Filed: Dec. 30, 2014

(51) Int. Cl. G06F 17/30; H04M 15/00; H04W 4/02

(52) U.S. Cl. CPC G06F 17/30241; G06F 17/30371; H04W 4/028; H04W 4/023; H04M 15/41

(57) ABSTRACT

A server includes a time-series generator to receive a sequence of unlabeled data records for a first user equipment. The unlabeled data records include values of measurements performed by the first user equipment on signals received from at least one base station. The server also includes a localization engine to estimate locations of the unlabeled data records based on the values of the measurements, a labeled dataset representing a channel model of a geographic area, and a map representative of the geographic area.

### BACKGROUND

1. Field of the Disclosure

The present disclosure relates generally to wireless communication systems and, more particularly, to call measurement data collected by wireless communication systems.

2. Description of the Related Art

Service providers can collect standardized or proprietary management data for user equipment. Examples of the collected management data may include Per Call Measurement Data (PCMD) records that capture statistics related to the user experience each time the user equipment performs a procedure such as attaching to the network, transmitting a service request to the network, initiating a handover, or other procedure. The PCMD records can be collected in real time by network elements such as base stations or eNodeBs, mobility management entities (MMEs), and serving gateways (SGWs). The PCMD records include an indicator of the identity of the user equipment so that the PCMD data can provide a per-process, per-user equipment view of the activities associated with the base stations, MMEs, or SGWs.

The PCMD records typically include several information fields including information indicating latency or time delays, channel quality, hand off events, and user equipment measurements and performance measurements such as reference signal received power (RSRP), throughput, call drop rates, and the like. However, PCMD records do not include location information for at least two reasons. First, some user equipment do not include global positioning system (GPS) functionality for determining their location. Second, in user equipment that include GPS functionality, processing the GPS signals and providing the resulting location information to the physical layer of the user equipment for inclusion in a PCMD record is complex and time-consuming. The PCMD records may therefore be referred to as unlabeled PCMD records because they are not labeled with location information.

### SUMMARY OF EMBODIMENTS

The following presents a summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In some embodiments, a method is provided for locating call measurement data. The method includes receiving, at a server, a sequence of unlabeled data records for a first user equipment. The unlabeled data records include values of measurements performed by the first user equipment on signals received from at least one base station. The method also includes estimating, at the server, locations of the unlabeled data records based on the values of the measurements, a labeled dataset representing a channel model of a geographic area, and a map representative of the geographic area.

In some embodiments, an apparatus is provided for locating call measurement data. The apparatus includes a time-series generator to receive a sequence of unlabeled data records for a first user equipment. The unlabeled data records include values of measurements performed by the first user equipment on signals received from at least one base station. The apparatus also includes a localization engine to estimate locations of the unlabeled data records based on the values of the measurements, a labeled dataset representing a channel model of a geographic area, and a map representative of the geographic area.

In some embodiments, a non-transitory computer-readable medium is provided for embodying a set of executable instructions for locating call measurement data. The set of executable instructions is to manipulate a processor to receive a sequence of unlabeled data records for a first user equipment. The unlabeled data records include values of measurements performed by the first user equipment on signals received from at least one base station. The set of executable instructions also manipulate the processor to estimate locations of the unlabeled data records based on the values of the measurements, a labeled dataset representing a channel model of a geographic area, and a map representative of the geographic area.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a map of a geographic area according to some embodiments.

FIG. 2 is a block diagram of a system for estimating locations of measurement data records based on a channel model and updating the channel model based on the estimated locations according to some embodiments.

FIG. 3 is a block diagram of a PCMD time-series generator according to some embodiments.

FIG. 4 is a flow diagram of a method for determining locations of measurement data records and updating a channel model based on the determined locations according to some embodiments.

FIG. 5 is a flow diagram of a method for determining locations of measurement data records and updating a channel model based on the determined locations using a particle filter and random forest regression according to some embodiments.

FIG. 6 is a plot illustrating a comparison between the actual path of user equipment and a tracked path indicating locations of the user equipment estimated based on a sequence of PCMD records according to some embodiments.

FIG. 7 is a plot illustrating variation in the tracking error determined based on the comparison of the actual path and the tracked path according to some embodiments.

FIG. 8 is a plot of a random forest cross validation profile according to some embodiments.

### DETAILED DESCRIPTION

Geometric principles (such as Observed Time Difference Of Arrival, OTDOA) can be used to estimate the location of user equipment when it generates a PCMD record (which is referred to herein as “the generation location of the PCMD record”) based on time delay information available in the PCMD record combined with information indicating the direction of signals received from neighboring base stations. To provide sufficient accuracy, the geometric approach requires time delays for at least three base stations. The geometric approach also requires that signals travel from the base station to the user equipment along a near-line-of-sight path. Neither of these conditions is likely to be satisfied for many user equipment, particularly in large metropolitan areas. Consequently, positional errors in the generation location of the PCMD record determined using the geometrical approach may be 100-150 meters (m) or larger. The geometric approach also ignores information available from other sources such as drive test data or ray tracing. The geometric approach further ignores the relationships between radiofrequency fingerprints of user equipment (e.g., the sequence of radiofrequency characteristics measured by the user equipment) and the location estimates for the user equipment.

The location of user equipment can also be estimated by comparing the measured signal strength of radio frequency signals from multiple access points to previously determined channel models for the multiple access points, a procedure known as radiofrequency fingerprinting. However, PCMD records only include radiofrequency measurements such as a reference signal received power (RSRP) or a reference signal received quality (RSRQ) for signals transmitted by the user equipment's serving base station. The limited radiofrequency information included in a PCMD record makes it difficult or impossible to accurately determine the generation location of the PCMD record using radiofrequency fingerprinting. The sparse or partial channel model information generated by drive testing, ray tracing, or other predictive models further reduces the accuracy of radiofrequency fingerprinting.

The accuracy of location estimates derived from PCMD records and the accuracy of channel models generated using drive test data or ray tracing may both be increased by estimating the generation location of a PCMD record associated with user equipment using information in a sequence of PCMD records for the user equipment and updating the channel models using the estimated generation location of the PCMD record. In some embodiments, the generation location of each PCMD record in a sequence of unlabeled PCMD records is determined based on values in the fields of the sequence of unlabeled PCMD records, a labeled dataset representing a channel model of a geographic area, mapping information representative of the geographic area, and a mobility model representing movement of the user equipment. For example, the generation location of each PCMD record may be treated as a hidden variable of a Markov model that generates the sequence of unlabeled PCMD records based on the values of the hidden variables (i.e., the locations of each PCMD record). The values of the hidden variables can be inferred from the transition probabilities between the hidden variables, which may be determined based on the labeled dataset, the mapping information, and the mobility model. The locations of the unlabeled PCMD records and the values in the fields of the unlabeled PCMD records may then be used as additional inputs to update the labeled dataset representing the channel model, e.g., using regression techniques such as multi-linear regression, a regression tree, or Random Forest regression. This process may be iterated for the sequence of unlabeled PCMD records until a convergence criterion is reached.

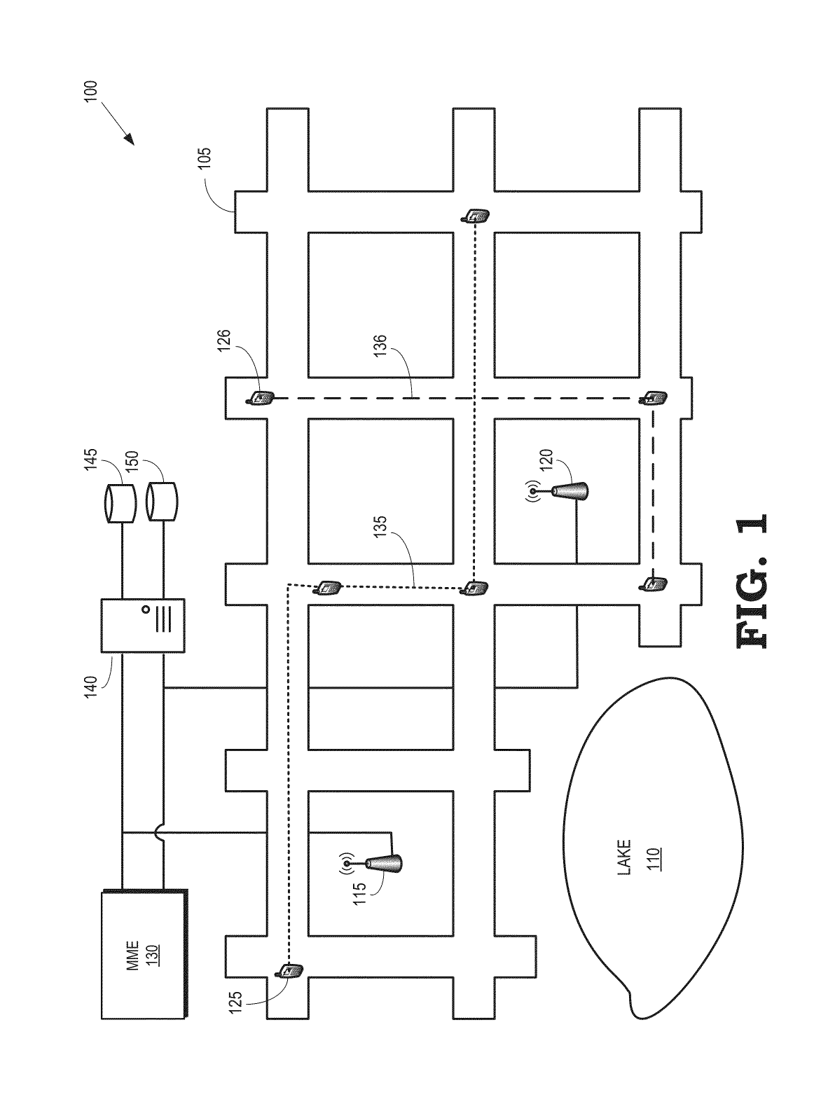

FIG. 1 is a map of a geographic area 100 according to some embodiments. The geographic area 100 is traversed by a road network 105 and includes a lake 110. Base stations 115, 120 provide wireless connectivity to one or more user equipment 125, 126 within the geographic area 100. As used herein, the term “base station” refers to any entity that provides wireless connectivity including base station routers, access points, access serving networks, macrocells, microcells, small cells, picocells, femtocells, and the like. Some embodiments of the base stations 115, 120 and the user equipment 125, 126 operate according to standards defined by the Third Generation Partnership Project (3GPP). However, some embodiments of the base stations 115, 120 or the user equipment 125 may operate according to other standards or protocols, either in addition to or instead of the standards defined by the 3GPP.

The base stations 115, 120 may be connected to a mobility management entity (MME) 130. Some embodiments of the MME 130 may be used to terminate non-access stratum (NAS) signaling associated with the user equipment 125, 126 and may perform authentication or authorization of the user equipment 125, 126. Some embodiments of the MME 130 may also establish dedicated bearers for communication with the user equipment 125, 126 and may be responsible for paging the user equipment 125, 126 when they are in an idle mode. The MME 130 may also be coupled to a serving gateway (not shown in FIG. 1), which may in turn be connected to a packet data network gateway (not shown in FIG. 1).

The user equipment 125, 126 may move through the geographic area 100, e.g., along one or more routes 135, 136 that traverse one or more of the roads in the road network 105. The user equipment 125, 126 may perform various measurements on signals received from the base stations 115, 120 as the user equipment 125, 126 move along the routes 135, 136. Information representative of the measurements performed by the user equipment can be captured in one or measurement data records such as Per-Call Measurement Data (PCMD) records. The user equipment 125, 126 may then provide the PCMD records to one or more of the base stations 115, 120, the MME 130, or other network entities such as serving gateways or packet data network gateways. The PCMD records generated by the user equipment 125, 126 may include one or more information fields that may have values indicating latency or time delays, channel quality, hand off events, as well as user equipment measurements and performance measurements such as reference signal received power (RSRP), a reference signal received quality (RSRQ), throughput, call drop rates, and the like.

Measurement data records collected by the user equipment 125, 126, such as PCMD records, are not labeled with information indicating the location of the user equipment 125, 126 at the time the measurement data record was generated. The measurement data records may therefore be referred to as unlabeled data or unlabeled PCMD records. As used herein, the term “unlabeled” will be understood to refer to signals that are not specifically associated with (e.g., labeled with) the location of the user equipment 125, 126 when the values of the fields in the measurement data records are determined. For example, the user equipment 125, 126 may not be able to determine their locations (e.g., latitudes and longitudes) when communicating with one or more of the base stations 115, 120 and consequently the user equipment 125, 126 may not be able to label their PCMD records with their location. Regardless of the capabilities of the user equipment 125, 126, unlabeled data does not include location information such as latitude/longitude. In contrast, labeled data typically includes the location information so that the measurement data record is “labeled” with the location information that indicates the locations of the user equipment 125, 126 at the time the measurement data records were generated.

A localization server 140 may be used to estimate locations of the user equipment 125, 126 at the time measurement data records were generated. The localization server 140 may then label the measurement data records with the corresponding location. Some embodiments of the localization server 140 receive a series of unlabeled measurement data records for the user equipment 125, 126. The unlabeled measurement data records may be received from the base stations 115, 120, the MME 130, or other network entities such as serving gateways. The unlabeled measurement data records include values of measurements performed by the user equipment 125, 126 on signals received from the base stations 115, 120 at different locations along the route 135. The localization server 140 may separate the unlabeled measurement data records received from the user equipment 125, 126 into separate per-user equipment sequences of unlabeled measurement data records.

The localization server 140 may then estimate the locations of the unlabeled measurement data records based on the values of the measurements indicated in the sequences of unlabeled measurement data records, a labeled dataset representing a channel model of signals produced by the base stations 115, 120 throughout the geographic area 100, a map representative of the geographic area 100, or locations of the base stations 115, 120. Including the map representative of the geographic area 100 in the location estimation procedure allows the localization server 140 to identify areas where user equipment 125, 126 are more likely to be located (e.g., on the roads indicated by the road network 105) and less likely to be located (e.g., in the lake 110). The labeled measurement data records may be stored in a database 145. Some embodiments of the localization server 140 used the labeled measurement data records to update the channel model of the signals produced by the base stations 115, 120, as discussed herein. The channel model may be stored in a database 150.

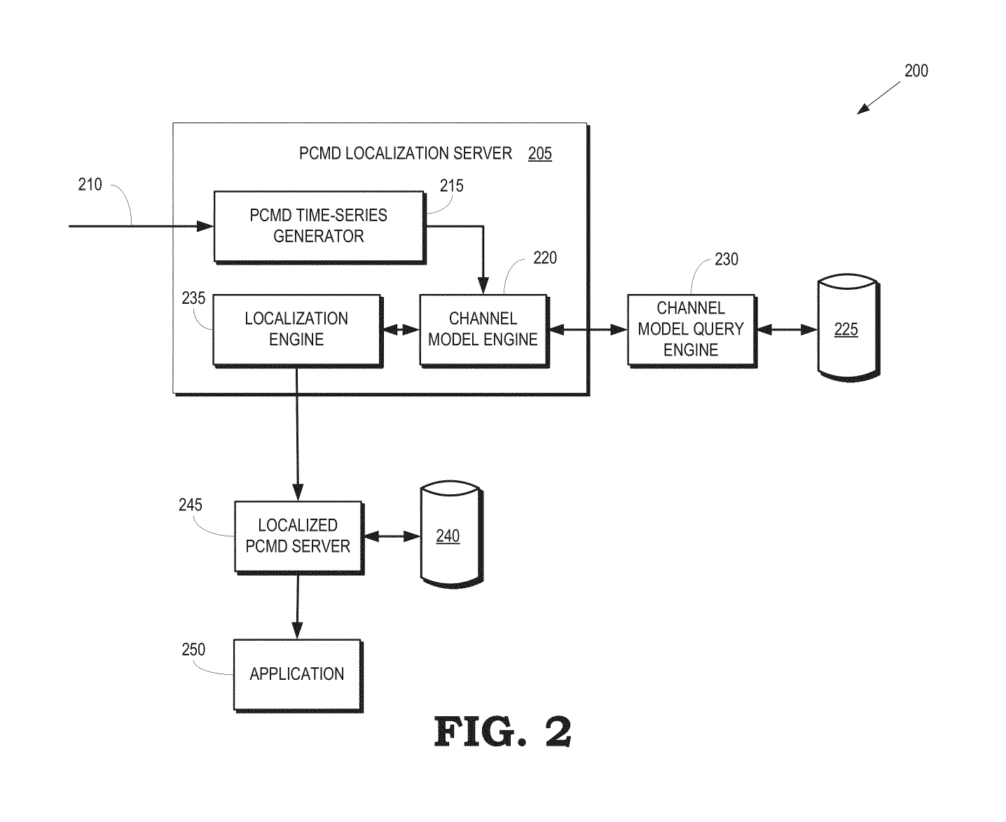

FIG. 2 is a block diagram of a system 200 for estimating locations of measurement data records based on a channel model and updating the channel model based on the estimated locations according to some embodiments. The system 200 may be implemented in some embodiments of the wireless communication system that provides coverage to the geographic area 100, e.g., in some embodiments of the server 140 and the databases 145, 150 shown in FIG. 1. The system 200 includes a PCMD localization server 205 that receives a series 210 of PCMD records associated with one or more user equipment. However, some embodiments of the server 205 may receive series of unlabeled measurement data records of other types or in other formats.

The PCMD localization server 205 includes a PCMD time-series generator 215 that receives the measurement data records and sorts or filters the measurement data records on the basis of identifiers of the associated user equipment. For example, the PCMD time-series generator 215 may receive a series of PCMD records that include PCMD records produced based on measurements performed by two different user equipment. The PCMD time-series generator 215 may selectively route the PCMD records associated with the different user equipment to create separate sequences of PCMD records for the different user equipment. Subsequent processing of the PCMD records may be performed based on the separate sequences of PCMD records for each user equipment. Processing of the per-user equipment sequences may be performed in series, in parallel, or concurrently.

The PCMD localization server 205 also includes a channel model engine 220 that is used to generate models of characteristics of the signals produced throughout a geographic area by base stations such as the base stations 115, 120 shown in FIG. 1. As used herein the term “channel model” refers to a model that produces an estimate of characteristics of air interface channels that would be measured at different locations by devices such as the user equipment 125, 126 shown in FIG. 1. The characteristics estimated by the channel model include a reference signal received power (RSRP) determined by measuring the received power of a reference signal generated by a base station, a reference signal received quality (RSRQ) determined by measuring a channel quality parameter such as a signal-to-noise ratio (SNR), and a timing advance that is determined by measuring a timing offset that should be applied to signals transmitted by the user equipment to align the timing of the user equipment to the base station timing. Some embodiments of the channel model engine 220 may generate channel models that include other characteristics of the air interface channels.

A database 225 may be used to store information representative of the channel model. Some embodiments of the database 225 may store initial sparse or partial channel model information that is determined using drive test data acquired using physical measurements of channel characteristics at one or more points within the geographic area, ray tracing based upon a two-dimensional or three-dimensional model of the geographic area, or other predictive models. For example, the database 225 may include estimated values of channel characteristic such as the RSRP, RSRQ, or timing advance as a function of location within the geographic area. Some embodiments of the database 225 may also store modified or updated channel models that are determined by the channel model engine 220 based upon the locations of PCMD records, as discussed herein.

The channel model engine 220 may access the database 225 using a channel model query engine 230. For example, the channel model engine 220 may transmit signals representative of queries to the channel model query engine 230 to request access to data stored in the database 225. The channel model query engine 230 may then retrieve the data from the database 225 and provide the requested data to the channel model engine 220. For another example, the channel model engine 220 may generate a modified or updated channel model (as discussed herein) and provide signals representative of the modified or updated channel model to the channel model query engine 230, which may store the modified or updated channel model in the database 225. Some embodiments of the channel model engine 220 may request information representing the channel model in response to receiving one or more PCMD records from the PCMD time-series generator 215.

A localization engine 235 may be used to estimate the locations of the PCMD records produced by the PCMD time-series generator 215 for each user equipment. Some embodiments of the localization engine 235 receive a series of PCMD records associated with a single user equipment. The localization engine 235 may then compare the values of the fields of the PCMD records in the series to the values of the characteristics in the channel model retrieved from the database 225 to estimate the locations of each of the PCMD records in the series. For example, the evolution of the values of the fields of the PCMD records in the series may be represented as hidden variables of a Hidden Markov Model. The hidden variables produce the observed variables represented by the values of the fields of the PCMD records. For example, the RSRP, RSRQ, or timing advances in the PCMD records may be treated as the observed values produced by the Hidden Markov Model in response to the user equipment being at the (hidden) locations of the PCMD records. The localization engine 235 can produce estimates of the (hidden) locations of the PCMD records in the series for the user equipment, e.g., using machine learning techniques described herein.

The localization engine 235 may label the PCMD records with the estimated locations and store the labeled PCMD records in a database 240. Some embodiments of the system 200 include a localized PCMD server 245 that provides access to the database 240. For example, the localization engine 235 may provide the labeled PCMD records to the localized PCMD server 245, which may then store the labeled PCMD records in the database 245. For another example, the localized PCMD server 245 may retrieve one or more of the labeled PCMD records from the database 240, e.g., in response to a request from an application 250. The localized PCMD server 245 may then provide the requested labeled PCMD records to the application 250. Some embodiments of the localized PCMD server 245 perform authorization or authentication procedures to ensure that the application 250 is authorized to access the localized PCMD records from the database 245.

The labeled PCMD records may also be used to update the channel model stored in the database 225. Some embodiments of the localization engine 235 provide the labeled PCMD records to the channel model engine 220, which may use the locations and the values of the channel characteristics indicated by the labeled PCMD records as additional data points for determining the channel model in the geographic area. For example, each labeled PCMD record may include a location of the corresponding user equipment when it measured the channel characteristics in the PCMD record, as well as values of the measured characteristic such as the RSRP, RSRQ, or the timing advance measured by the user equipment. The new data points may be combined with data points corresponding to previously labeled PCMD records associated with one or more user equipment and the initial sparse or partial channel model produced by drive testing, ray tracing, or other predictive models. The channel model engine 220 may then use the combined dataset to generate a new estimate of the channel model, which may be stored in the database 225.

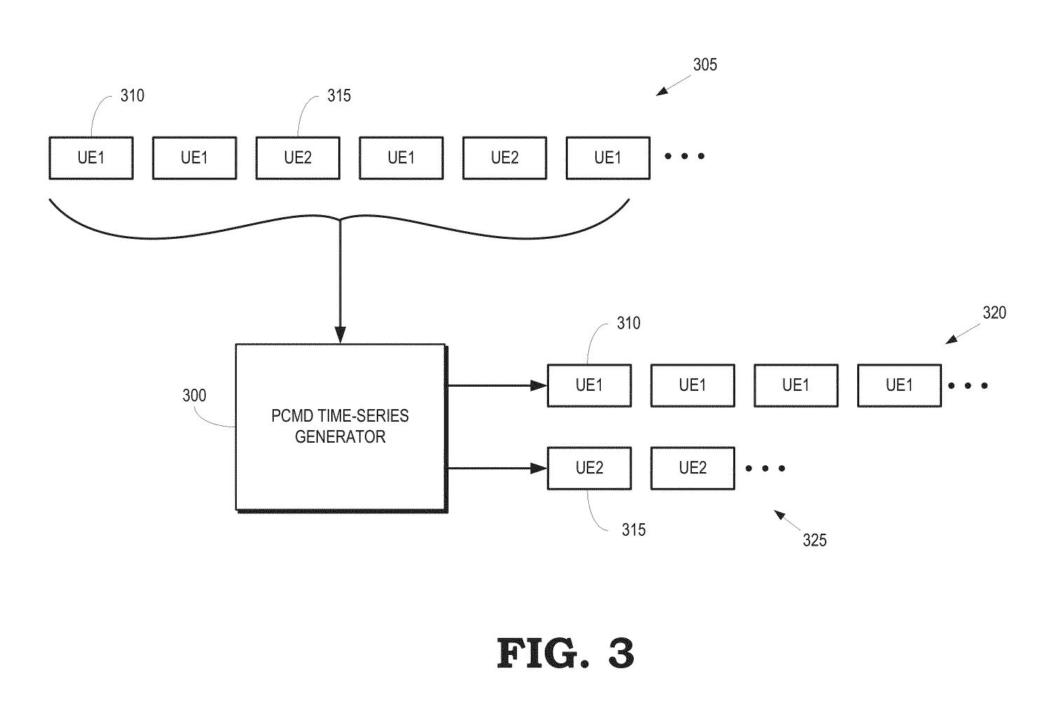

FIG. 3 is a block diagram of a PCMD time-series generator 300 according to some embodiments. The PCMD time-series generator 300 may be implemented in some embodiments of the PCMD time-series generator 215 shown in FIG. 3. The PCMD time-series generator 300 receives a series 305 of PCMD records that includes one or more PCMD records 310 (only one indicated by a reference numeral in the interest of clarity) received from a first user equipment (UE1) and one or more PCMD records 315 (only one indicated by a reference numeral in the interest of clarity) received from a second user equipment (UE2). Some embodiments of the series 305 may include PCMD records provided by additional user equipment.

The PCMD time-series generator 300 may then filter or sort the PCMD records 310, 315 in the series 305 based on an identifier of the user equipment included in the PCMD records 310, 315. For example, the PCMD records 310, 315 may include a field that holds a value representing a unique identifier of the user equipment so that the value of the field in the PCMD record 310 indicates the first user equipment (UE1) and the value of the field in the PCMD record 315 indicates the second user equipment (UE2). The PCMD time-series generator 300 may then filter or sort the PCMD record 310, 315 to produce the sequence 320 of the PCMD records 310 associated with the first user equipment and the sequence 325 of the PCMD records 315 associated with the second user equipment. The sequences 320, 325 may include the PCMD records 310, 315 aggregated over a predetermined time interval such as a five-minute time interval. Some embodiments of the PCMD time-series generator 300 can provide the sequences 320, 325 to other elements such as the channel model engine 220 in the PCMD localization server 205 shown in FIG. 2.

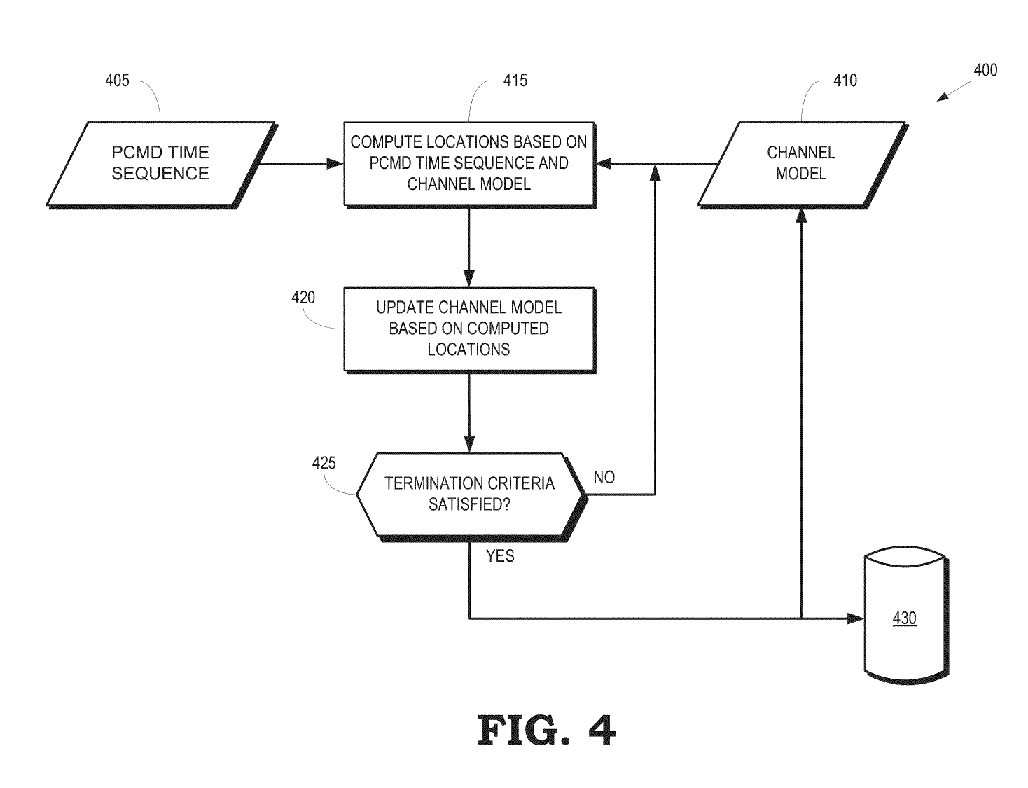

FIG. 4 is a flow diagram of a method 400 for determining locations of measurement data records and updating a channel model based on the determined locations according to some embodiments. The method 400 may be implemented in some embodiments of the PCMD localization server 205 shown in FIG. 2. Block 405 provides data representative of one or more sequences of unlabeled PCMD records such as the sequences 320, 325 shown in FIG. 3. Block 410 provides data representative of a channel model over a geographic area such as the channel model stored in the database 225 shown in FIG. 2. At block 415, locations of the PCMD records in the PCMD time sequences for each user equipment are computed based on the PCMD time sequences and the channel model. The locations of the PCMD records may be determined by a localization engine such as the localization engine 235 shown in FIG. 2.

Some embodiments of the localization engine determine the locations of the PCMD record by modeling the PCMD time sequence for each user equipment as a Hidden Markov Model and estimating the (hidden) locations of the PCMD records using an expectation maximization algorithm. For example, the sequence of locations of the user equipment and a geographic area may be represented by the variables xᵢ, i=1,2, . . . , m in a road graph G that represents a map of a geographic area such as the geographic area 100 shown in FIG. 1. The Hidden Markov Model is determined by probabilities for transitions between each of the locations xi. The transition probabilities in the road graph G may be represented as P(xᵢ₊₁|xᵢ; G), which may be determined by a mobility model of the user equipment. For example, the mobility model may indicate that the user equipment updates its speed according to the equation:

vᵢ=e^{-βτ}vᵢ₋₁+(1−e^{-βτ})δ_{τ}

where Tᵢ are the times associated with the unlabeled PCMD records, τ=Tᵢ−Tᵢ₋₁, δ_{τ}˜N(0, σ_{τ}²), and β is a scaling constant. The unlabeled PCMD records are represented by Rᵢ and each PCMD record is independent of the previous PCMD records. The (hidden) locations may then be determined using a filtering algorithm represented by:

$${\{ {\hat{x}}_{i} \}}_{i = 1}^{m} = arg {max}_{{\{ {x}_{i} \}}_{i = 1}^{m} ∈ {V}^{m}} P ( {\{ {x}_{i} \}}_{i = 1}^{m} \vert {\{ {R}_{i} , {T}_{i} \}}_{i = 1}^{m} , G , {𝒟}_{1} )$$

Labeled data provided by the channel model is represented in the above equation by D₁. Examples of filtering algorithms that may be used in different embodiments include particle filtering, extended Kalman filtering, or a Viterbi algorithm.

At block 420, the channel model is updated based on the computed locations, e.g., using the labeled PCMD records produced by the localization engine. Some embodiments of the localization engine determine the channel model represented by the RSRP, RSRQ, or timing advances throughout the geographic area by applying regression to the data points provided by the labeled PCMD records and previously acquired data points such as previously computed labeled PCMD records or initial sparse or partial channel models derived from drive testing, ray tracing, or predictive modeling. For example, multi-linear regression may be performed over a set of basis functions such as functions that are powers of a logarithm of a distance from a serving base station because the received power in decibels is known to vary logarithmically with distance from the base station. This approach has a runtime of O(n) for n data points. For another example, the channel model may be determined using regression trees for the latitude and longitude of the user equipment. This approach has a runtime of O(n log n) for n data points. For yet another example, the channel model may be determined based on a random forest collection of regression trees sampled over different subsets of the data points. In some cases, random forest regression outperforms individual regression trees, albeit with slightly higher run times.

The method 400 may be iterated until a termination criterion is satisfied at decision block 425. Examples of termination criteria include a number of iterations exceeding a threshold number of iterations, a fractional change per iteration in one or more values of one or more characteristics of the channel model falling below a threshold change, and the like. If the termination criterion is satisfied at decision block 425, the updated channel model is stored in a database 430, which may be implemented in some embodiments of the database 225 shown in FIG. 2.

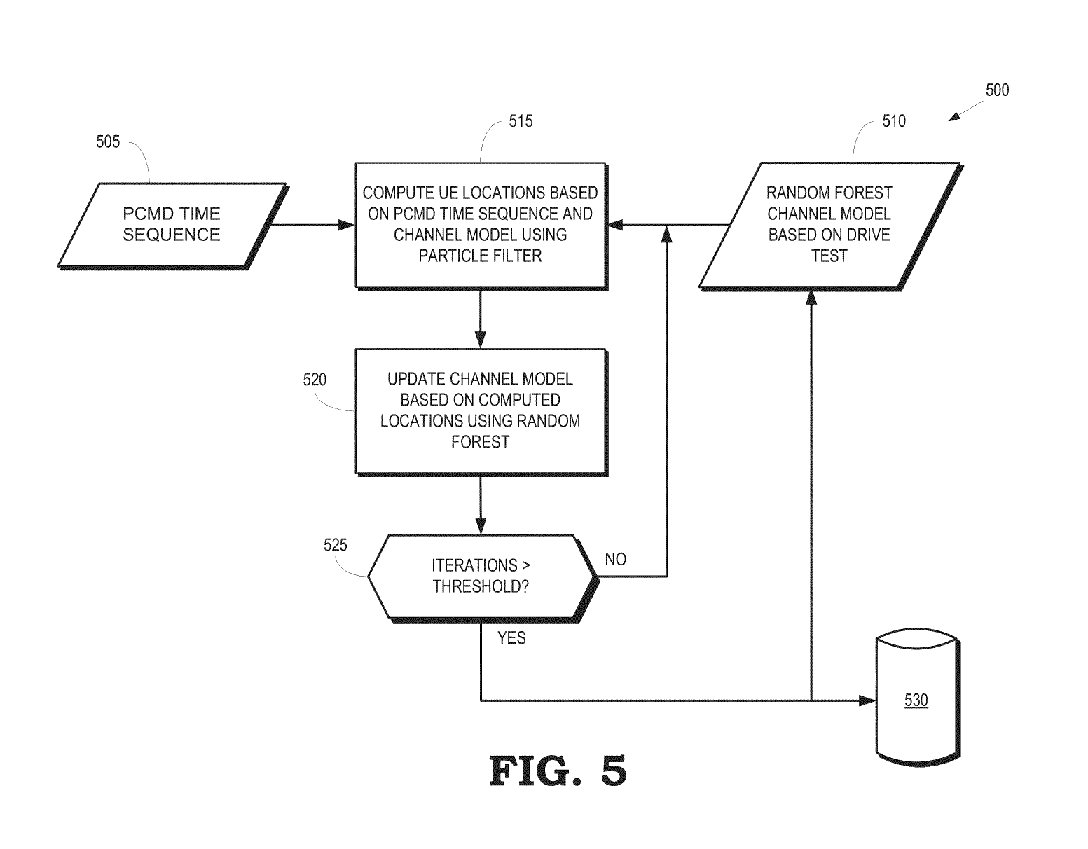

FIG. 5 is a flow diagram of a method 500 for determining locations of measurement data records and updating a channel model based on the determined locations using a particle filter and random forest regression according to some embodiments. The method 500 may be implemented in some embodiments of the PCMD localization server 205 shown in FIG. 2. Block 505 provides data representative of one or more sequences of unlabeled PCMD records such as the sequences 320, 325 shown in FIG. 3. Block 510 provides data representative of a channel model over a geographic area such as the channel model stored in the database 225 shown in FIG. 2. The channel model is determined using random forest regression on a labeled dataset acquired using drive testing. For example, the labeled dataset may include information indicating locations and values of measurements of RSRP, RSRQ, or timing advances acquired during one or more drive tests. Random forest regression is an ensemble learning method that operates by constructing a plurality of decision trees based on a set of observations such as the labeled dataset acquired during drive testing. Each decision tree is a predictive model that maps the values of the measurements at the known locations to estimated values of the measured parameters at other locations. Random forest regression generates the decision trees by projecting the labeled dataset onto a randomly chosen subspace for each decision tree and outputs a class that is the mode of the classes output by the individual decision trees.

At block 515, locations of the PCMD records in the PCMD time sequences for each user equipment are computed based on the PCMD time sequences and the channel model. The locations of the PCMD records may be determined by a localization engine such as the localization engine 235 shown in FIG. 2. The localization engine uses a particle filter algorithm to determine the locations of the PCMD records. For example, the localization engine may initially define a set of particles. Each particle represents a sequence of possible locations of the PCMD records acquired by the user equipment. The localization engine may then assign weights or likelihoods that indicate the probability that the corresponding particle represents the actual sequence of locations of the PCMD records. Particles with low weights or likelihoods indicating a low probability that the particle represents the actual sequence of locations of the PCMD records are dropped from the distribution of particles. The weights or likelihoods are then updated and the process is iterated until the particle with the highest weight or likelihood is identified as the particle that represents the actual sequence of locations of the PCMD records.

Some embodiments of the particle filter technique may be represented by the following pseudocode:

Algorithm 2 LocalizeUEpf ( [symbol] ₂, C, G, Nₜₕ)

| | |
|---|---|
| 1: | Sample N particles [symbol] ⱼ = {\hat{x}₁^{(j)}, \hat{v}₁^{(j)},}, j = 1, . . . , |
| | N from prior distribution p(\tilde{x}₁, \tilde{v}₁\|G) |
| 2: | Initialize importance weights ŵⱼ^{(j) ←} p(\tilde{R}₁\|\hat{x}₁^{(j)}, C), j = 1, . . . , N |
| 3: | Normalize w₁^{(j)} ← ŵ₁^{(j)}/Σₗ₌₁^{^{N}}ŵ₁^{(l)}, j = 1, . . . , N |
| 4: | for i = 2 to m do |
| 5: | for j = 1 to N do |
| 6: | Sample \hat{x}ᵢ^{(j)} from distribution p(\hat{x}ᵢ^{(j)}\|\hat{x}ᵢ₋₁^{(j)},\hat{v}ᵢ₋₁^{(j)}, G) |
| 7: | Update weight ŵᵢ^{(j)} ← ŵᵢ₋₁^{(j)} × p(\tilde{R}ᵢ\|\hat{x}ᵢ^{(j)}, C) |
| 8: | Update speed \hat{v}ᵢ^{(j)} = d_{G}(\hat{x}ᵢ^{(j)},\hat{x}ᵢ₋₁^{(j)})/(Tᵢ − Tᵢ₋₁) |
| 9: | [symbol] ⱼ ← [symbol] ⱼ∪ {\hat{x}ᵢ^{(j)},\hat{v}ᵢ^{(j)}} |
| 10: | end for |
| 11: | $Normalize {w}_{i}^{( j )} ← \frac{{\hat{w}}_{i}^{( j )}}{{\sum }_{l = 1}^{N} {\hat{w}}_{i}^{( l )}}$ |
| 12: | ${\hat{N}}_{eff} ← \frac{1}{{\sum }_{l = 1}^{N} {( {w}_{i}^{( l )} )}^{2}}$ |
| 13: | if \hat{N}_{eff} < Nₜₕ then |
| 14: | Sample N particles with replacement from current particles set |
| | { [symbol] j}ⱼ₌₁^{N} with probabilities {ŵᵢ^{(j)}}ⱼ₌₁^{N}. Update particle set with the |
| | new sampled set |
| 15: | wᵢ^{(j)} ← 1/N for j = 1, . . . , N |
| 16: | end if |
| 17: | end for |
| 18: | j* = arg max _{j=1,} _{. . . , N} wₘ^{(j)} |
| 19: | Output location estimate {\hat{x}ᵢ^{(j*)}}ᵢ₌₁^{m} |
| 10: | Output distribution p({\hat{x}^{(j)}}ᵢ₌₁^{m}\|\tilde{R}ᵢ}ᵢ₌₁^{m}, C, G) = wₘ^{(j)} for j = 1 to N |

In the pseudocode representing Algorithm 2, the variable Tᵢ represents the time at which the user equipment sends a PCMD record represented by Rᵢ, vᵢ represents the speed of the user equipment at time Tᵢ, and d_{G}(x, y) represents the shortest distance between the points x, y ∈ V calculated along the edges of the graph G. The probability distributions used in Algorithm 2 may be defined as:

$$p ( {\hat{x}}_{i} \vert {\hat{x}}_{i - 1} , {\hat{v}}_{i - 1} , G ) = \frac{1}{C {σ}_{r} ( 1 - {e}^{- {β}_{T}} ) τ \sqrt{2 π}} exp ( - \frac{{( {d}_{G} ( {\hat{x}}_{i} , {\hat{x}}_{i - 1} ) - τ {\hat{v}}_{i - 1} {e}^{- βτ} )}^{2}}{2 {σ}_{τ}^{2} {{τ}^{2} ( 1 - {e}^{- βτ} )}^{2}} )$$

$$p ( {\tilde{R}}_{i} \vert {\hat{x}}_{i} , C ) = p ( {TA}_{i} \vert {\hat{x}}_{i} ) {\prod }_{k ∈ S} \frac{1}{{σ}_{k} ( {\hat{x}}_{i} ) \sqrt{2 π}} exp ( - \frac{{( {\tilde{P}}_{k}^{i} - {\hat{P}}_{k} ( {\hat{x}}_{i} ) )}^{2}}{2 {{σ}_{k} ( {\hat{x}}_{i} )}^{2}} )$$

$$p ( {TA}_{i} \vert {\hat{x}}_{i} ) = \frac{1}{{σ}_{TA} \sqrt{2 π}} exp ( - \frac{1}{2 {σ}_{TA}^{2}} {( {TA}_{i} - ‖ {\hat{x}}_{i} - {y}_{{k}^{*}} ‖ / c )}^{2} )$$

However, some embodiments may use other forms for the probability distributions.

At block 520, the channel model is updated based on the computed locations of the PCMD records using random forest regression. Some embodiments of the localization engine determine the channel model represented by the RSRP, RSRQ, or timing advances throughout the geographic area by applying regression to the data points provided by the labeled PCMD records and previously acquired data points such as previously computed labeled PCMD records or the initial channel model derived by applying random forest regression to the labeled data acquired during drive testing.

The method 500 is iterated until a number of iterations of the method 500 exceeds a threshold number of iterations at decision block 525. Once the number of iterations exceeds the threshold number of iterations, the updated channel model is stored in a database 530, which may be implemented in some embodiments of the database 225 shown in FIG. 2.

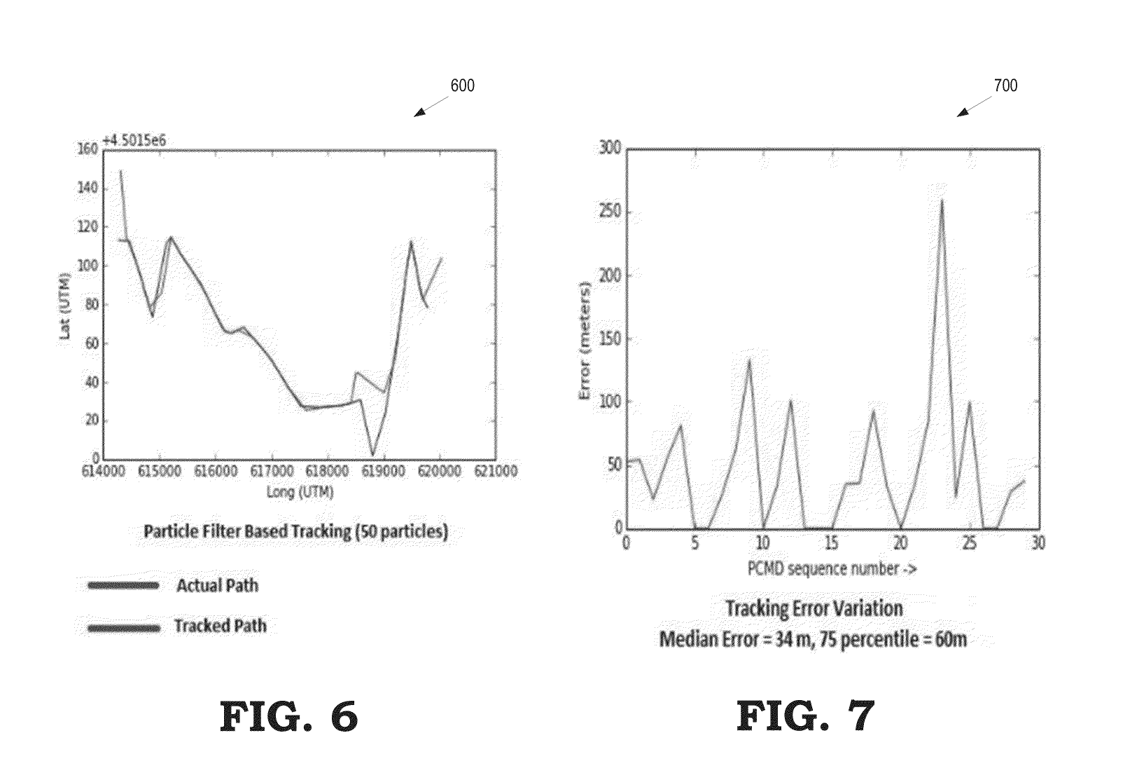

FIG. 6 is a plot 600 illustrating a comparison between the actual path of user equipment and a tracked path indicating locations of the user equipment estimated based on a sequence of PCMD records according to some embodiments. The vertical axis in FIG. 6 represents latitude and the horizontal axis indicates longitude. FIG. 7 is a plot 700 illustrating variation in the tracking error determined based on the comparison of the actual path and the tracked path according to some embodiments. The vertical axis in FIG. 7 represents the error in meters and the horizontal axis represents the sequence numbers of the PCMD records.

The tracked path is computed using a particle filter tracking technique such as the method 500 shown in FIG. 5. The plot 600 was developed using drive testing data, which was split into two parts: a first portion for generating training data for the initial channel model (e.g., using random forest regression) and a second portion for generating unlabeled PCMD records that correspond to the PCMD records that would be generated by user equipment driving along a route corresponding to the second portion of the drive testing data. Consequently, the first portion provides a “ground truth” dataset with known locations that can be compared to the locations estimated based on the unlabeled PCMD records generated from the second portion.

Embodiments of the techniques described herein can localize PCMD records to within a median error of 34 meters (m), which is considerably better than the median error of 100-150 m provided by conventional location estimation techniques. Moreover, the embodiments used to produce plot 600 and plot 700 did not incorporate information indicating locations of the base stations within the wireless communication system. Incorporating this information according to some embodiments described herein would likely improve the accuracy of the localization technique.

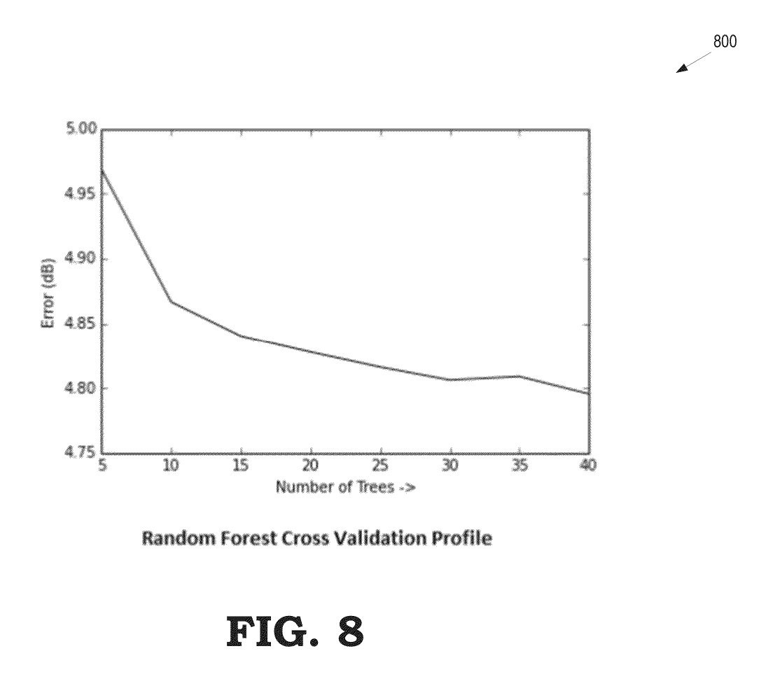

FIG. 8 is a plot 800 of a random forest cross validation profile according to some embodiments. The plot 800 was produced using embodiments of the method 500 shown in FIG. 5. The vertical axis represents error in decibels (dB) and the horizontal axis represents the number of trees used in the random forest regression. The plot 800 indicates that embodiments of the techniques described herein can predict the channel model within less than 5 dB.

Embodiments of the techniques described herein have a number of advantages over conventional techniques for determining the location of user equipment. Embodiments of the techniques described herein provide highly accurate location information that is significantly more accurate than conventional PCMD localization techniques. The approach is scalable and can be implemented in a cloud using modern “big data” computation techniques. Some embodiments of the techniques described herein are highly scalable and can process a high volume and rate of measurement data records. This is particularly important in urban environments. For example, it has been estimated that the measurement data records produced by user equipment in New York City produces terabytes of data in a week. Moreover, user equipment in major metropolitan areas can produce millions of PCMD records every minute.

Minimal radiofrequency information is needed to implement embodiments of the techniques described herein. Some embodiments of the techniques described herein can estimate the locations of measurement data records using information from a small number of base stations and, in some cases, from a single base station. For example, the radiofrequency measurements (RSRP or RSRQ) in the PCMD records may only be performed based on signals received from a single base station that is serving the user equipment that performs the measurements. The technique may be in further improved using RSRP measurements for one neighbor cell proximate a serving cell. In contrast, localization techniques developed by the Wi-Fi and robotics communities require measurements of radio signal strengths from multiple access points. Some embodiments of the techniques described herein are minimally affected by the multipath effects that impair the performance of conventional localization techniques based on GPS in highly urban metropolitan areas.

Updating the channel models based upon the estimated locations of the measurement data records also has a number of advantages over the conventional practice. Conventional channel models are determined based on drive test data, ray tracing, or predictive statistical models. Drive test data a further require matching of the reported location of the measurement to an estimated true location. However, the true measurements that are available in map-matched drive test data are usually sparse across the city because drive tests are expensive and the coverage produced by the drive tests is sparse. Furthermore, predictive path-loss approaches (statistical, deterministic, or in between) may not capture accurately enough the signal strength variability in different locations. Thus, the initial channel model is likely to be incomplete and only partially reliable. Some embodiments of the techniques described herein produce an improved statistical channel model based on measurements performed by the user equipment. This additional data may augment existing datasets produced by drive testing, ray tracing, or predictive methods. Incomplete or sparse data may therefore be filled in using the locations generated from the stream of measurement data records. Some embodiments of the techniques described herein may also account for the velocity of the user equipment by using the timing-series of PCMD records. The reliability of the channel model may also be improved by iteratively updating the channel model based on the most recent measurement data records.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
receiving, at a server, a sequence of unlabeled data records for a first user equipment, the unlabeled data records including values of measurements performed by the first user equipment on signals received from at least one base station; and
estimating, at the server, locations of the unlabeled data records based on the values of the measurements, a labeled dataset representing a channel model of a geographic area, and a map representative of the geographic area.

2. The method of claim 1, further comprising:
updating the channel model based on the values of the measurements and the locations of the unlabeled data records; and
storing the updated channel model in a first database.

3. The method of claim 2, wherein estimating the locations of the unlabeled data records comprises iteratively estimating the locations of the unlabeled data records based on the updated channel model and updating the channel model based on updated locations of the unlabeled data records until a convergence criterion is satisfied.

4. The method of claim 1, further comprising:
generating labeled data records based on the locations and the unlabeled data records; and
storing the labeled data records in a second database.

5. The method of claim 4, further comprising:
providing the labeled data records to an application in response to a request from the application.

6. The method of claim 1, wherein receiving the sequence of unlabeled data records for the first user equipment comprises receiving a series of unlabeled data records for the first user equipment and at least one second user equipment, and generating the sequence of unlabeled data records for the first user equipment from the series of unlabeled data records.

7. The method of claim 1, wherein receiving the sequence of unlabeled data records including the values of the measurements performed by the first user equipment comprises receiving a sequence of unlabeled data records that include values of at least one of a reference signal received power, a reference signal received quality, and a timing advance measured by the first user equipment.

8. The method of claim 1, wherein estimating the locations of the sequence of unlabeled data records comprises associating likelihoods with a plurality of particles representative of a corresponding plurality of sets of locations of the unlabeled data records based on a mobility model of the first user equipment and the map representative of the geographic area.

9. The method of claim 8, wherein estimating the locations of the sequence of unlabeled data records comprises iteratively selecting subsets of the plurality of particles based on the likelihoods until one of the plurality of particles is selected to represent the locations.

10. An apparatus comprising:
a time-series generator to receive a sequence of unlabeled data records for a first user equipment, the unlabeled data records including values of measurements performed by the first user equipment on signals received from at least one base station; and
a localization engine to estimate locations of the unlabeled data records based on the values of the measurements, a labeled dataset representing a channel model of a geographic area, and a map representative of the geographic area.

11. The apparatus of claim 10, further comprising:
a channel model engine to update the channel model based on the values of the measurements and the locations of the unlabeled data records; and
a first database to store the updated channel model.

12. The apparatus of claim 11, wherein the localization engine and the channel model engine iteratively estimate the locations of the unlabeled data records based on the updated channel model and update the channel model based on updated locations of the unlabeled data records until a convergence criterion is satisfied.

13. The apparatus of claim 10, wherein the localization engine generates labeled data records based on the locations and the unlabeled data records, the apparatus further comprising:
a second database to store the labeled data records.

14. The apparatus of claim 13, further comprising:
a server to access the labeled data records from the second database and provide the labeled data records to an application in response to a request from the application.

15. The apparatus of claim 10, wherein the time-series generator receives a series of unlabeled data records for the first user equipment and at least one second user equipment, and wherein the time-series generator generates the sequence of unlabeled data records for the first user equipment from the series of unlabeled data records.

16. The apparatus of claim 10, wherein the time-series generator receives a sequence of unlabeled data records that include values of at least one of a reference signal received power, a reference signal received quality, and a timing advance measured by the first user equipment.

17. The apparatus of claim 10, wherein the localization engine associates likelihoods with a plurality of particles representative of a corresponding plurality of sets of locations of the unlabeled data records based on a mobility model of the first user equipment and the map representative of the geographic area.

18. The apparatus of claim 17, wherein the localization engine iteratively selects subsets of the plurality of particles based on the likelihoods until one of the plurality of particles is selected to represent the locations.

19. A non-transitory computer readable medium embodying a set of executable instructions, the set of executable instructions to manipulate at least one processor to:
receive a sequence of unlabeled data records for a first user equipment, the unlabeled data records including values of measurements performed by the first user equipment on signals received from at least one base station; and
estimate locations of the unlabeled data records based on the values of the measurements, a labeled dataset representing a channel model of a geographic area, and a map representative of the geographic area.

20. The non-transitory computer readable medium of claim 19, wherein the set of executable instructions manipulate the at least one processor to iteratively estimate the locations of the unlabeled data records based on the channel model and update the channel model based on updated locations of the unlabeled data records until a convergence criterion is satisfied.
